(19) United States
(12) Patent Application Publication
(10) Pub. No.: US 2007/0062215 A1
(43) Pub. Date: Mar. 22, 2007

(54) Condenser

(75) Inventors: Hidekazu Yamazaki, Tokyo (JP); Masayoshi Shinhama, Tokyo (JP); Minoru Tsuchiya, Tokyo (JP); Yasuhito Makishima, Tokyo (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/522,444

(22) Filed: Sep. 18, 2006

(30) Foreign Application Priority Data
Sep. 21, 2005 (JP) 2005-273697

(51) Int. Cl. F25B 39/04; F28F 9/02; B23P 15/26; B21D 53/00

(52) U.S. Cl. 62/509; 165/175; 29/890.043

(57) ABSTRACT

A condenser includes a pair of tanks, at least one of the tanks having a communicating hole, a condenser core arranged between the tanks and having fins and tubes fluidically connected with the tanks, and a connector having a connecting hole. A peripheral portion of the communicating hole is pressed into the connecting hole to form a burring portion which is caulked on an inner face forming the connecting hole so that the connector and the tank are temporarily fixed with each other, and facing portions of the tank and the connector are integrally fixed with each other by blazing. The inner surface of the connecting hole is provided with a holding groove to receive an inserted projecting portion formed on a part of an outer surface of the burring portion for holding the connector to the tank.

### BACKGROUND OF THE INVENTION

1. Field of the Invention

The present invention relates to a condenser which has a tank fixed with a connector by caulking and brazing.

2. Description of the Related Art

A conventional condenser of this kind is disclosed in Japanese Patent laid-open publication No. 2004-219027. The conventional condenser includes a pair of tanks and a condenser core having a plurality of tubes and fins and arranged between the tanks. One of the tanks is fixed at its top portion with an inlet connector for connecting a pipe, and the other thereof is fixed at its bottom portion with an outlet connector for connecting a pipe. Specifically, the tanks are formed with a communicating hole and the connectors are formed with a connecting hole, so that they can be fluidically communicated with each other.

The connectors are fixed to the tanks, respectively, by caulking and brazing as follows. The tank and the connector are arranged so that the communicating hole and the connecting hole are aligned with each other, and then a punch is press-fitted from a tank side into the holes to form a burring portion of the tank and caulk the burring portion on an inner surface of the connecting hole so as to temporarily fix them together. The punch is drawn out from the holes, and then the temporarily fixed tank and connector are placed with brazing filler metal in a heating furnace to be blazed. Incidentally, in this blazing process, a temporarily assembled tanks and condenser core are also blazed to integrally form a condenser.

The above known conventional condenser, however, encounters such the following problem. The temporarily fixed burring portion of the tank and the inner surface of the connecting hole of the connector cause looseness therebetween at times. In addition, looseness also occurs at times between the burring portion of the tank and the inner surface of the connector due to a thermal expansion difference therebetween in the blazing process. The looseness causes undesirable fixing by blazing.

It is, therefore, an object of the present invention to provide a condenser which overcomes the foregoing drawbacks and can temporarily fix a tank and a connector firmly with each other and blaze them with each other as intended.

### SUMMARY OF THE INVENTION

According to the aspect of the present invention there is provided a condenser including a pair of tanks, at least one of the tanks being formed with a communicating hole, a condenser core arranged between the tanks and having a plurality of tubes and fins where one end portions of the tubes are fluidically connected with one of the tanks and the other end portions of the tubes are fluidically connected with the other of the tanks, and a connector having a connecting hole that can fluidically communicate with the communicating hole of the tank. A peripheral portion of the communicating hole is pressed into the connecting hole of the connector to form a burring portion which is caulked on an inner face forming the connecting hole of the connector so that the connector and the tank are temporarily fixed with each other, and facing portions of the tank and the connector are integrally fixed with each other by blazing. The inner surface of the connecting hole is provided with a holding groove to receive an inserted projecting portion formed on a part of an outer surface of the burring portion for holding the connector to the tank.

Therefore, the condenser can temporarily fix the tank and the connector firmly with each other, thereby blazing them with each other as intended.

Preferably, the holding groove has a vertical wall portion formed vertically to a central axis of the connecting hole and a slope wall portion decreasing a depth of the holding groove as a depth position of the slope wall portion goes away in an axial direction of the connecting hole from the tank.

Therefore, the vertical wall portion ensures firm fixing of the tank and the connector, and the slope wall portion also ensures the fixing by deforming the part of the burring portion to form the inserted projecting portion, where it is deformed easily into the bottom of the holding groove so as to be inserted into the bottom of the holding groove along the vertical wall portion and extend along the slope wall portion the axial direction of the connecting hole for increasing its axial strength.

Preferably, the facing portions of the tank and the connector are integrally fixed with each other by blazing.

Therefore, the tank and the connector can be integrally fixed more firmly with each other.

Preferably, the connector has an opening portion that is rimmed to have a slope surface on an inner edge thereof to be contactable with a root portion of the burring portion.

Therefore, this can prevent concentration of stress in the root portion of the burring portion when the burring portion is fixed into the connector.

### BRIEF DESCRIPTION OF THE DRAWINGS

The objects, features and advantages of the present invention will become apparent as the description proceeds when taken in conjunction with the accompanying drawings, in which:

FIG. 1 is a front view showing a condenser, including a condenser core, a left tank fixed with upper and lower connectors, and a right tank equipped with a receiver, of an embodiment according to the present invention;

FIG. 2 is an enlarged fragmentary cross-sectional front view showing the left tank and the condenser core of the condenser shown in FIG. 1;

FIG. 3 is an expanded view showing the left tank and the upper and lower connectors of the condenser shown in FIG. 1;

FIG. 4 is an expanded and enlarged fragmentary perspective view showing a top portion, indicated by a circle A in FIG. 1, of the left tank and the upper connector, which are shown in FIGS. 1 and 3;

FIG. 5 is an expanded and enlarged fragmentary perspective view showing an intermediate portion, indicated by a circle B in FIG. 1, of the left tank shown in FIGS. 1 and 3;

FIG. 6 is an expanded and enlarged fragmentary perspective view showing a bottom portion, indicated by a circle C, of the left tank and the lower connector, which are shown in FIGS. 1 and 3;

FIG. 7 is an enlarged front view showing the lower connector shown in FIGS. 1, 3 and 6;

FIG. 8 is a plan view showing the lower connector shown in FIGS. 7;

FIG. 9 is a bottom plan view showing the lower connector shown in FIG. 7;

FIG. 10 is a right side view showing the lower connector shown in FIG. 7;

FIG. 11 is a left side view showing the lower connector shown in FIG. 7;

FIG. 12 is a cross sectional view showing the lower connector shown in FIG. 7, taken along the line S12-S12 in FIG. 8;

FIG. 13 is an enlarged cross sectional view showing a portion, indicated by a circle D in FIG. 12, formed with a holding groove of the lower connector shown in FIG. 7;

FIG. 14 is a perspective view explaining how a tank plate of the left tank and the lower connector are temporarily assembled with each other;

FIG. 15A is an enlarged fragmentary view showing a temporary assembly state before a punch is inserted into a communicating hole of the tank plate and a connecting hole of the lower connector where the communicating hole and the connecting hole are aligned with each other, FIG. 15B is an enlarged fragmentary view showing the contemporary assembly state where the punch is inserted into the communicating hole and the connecting hole to caulk a burring portion of the tank plate and the lower connector on each other, and FIG. 15C is an enlarged fragmentary view showing the temporary state after the punch is drawn out from the communicating hole and the connecting hole;

FIG. 16 is a perspective view showing the temporary state where the upper connector is temporarily fixed to the top portion of the temporarily assembled left tank;

FIG. 17 is a perspective view showing the temporary assembly state where the intermediate portion of the left tank is temporarily assembled;

FIG. 18 is a perspective view showing the temporary state where the lower connector is temporarily fixed to the bottom portion of the temporarily assembled left tank;

FIG. 19 is a perspective view explaining how an upper mounting bracket is temporarily fixed to the top portion of the temporarily assembled left tank;

FIG. 20 is a perspective view explaining how a lower mounting bracket is temporarily fixed to the bottom portion of the temporarily assembled left tank; and

FIG. 21 is a perspective view showing the temporary state of the intermediate portion of the left tank.

### DESCRIPTION OF THE PREFERRED EMBODIMENTS

Throughout the following detailed description, similar reference characters and numbers refer to similar elements in all figures of the drawings.

A condenser of an embodiment according to the present invention will be described with reference to the accompanying drawings.

A condenser 100 is used for an air conditioning system and mounted on a front portion of a not-shown vehicle body of a motor vehicle. In this description, terms “left” and “right” are used with respect to the vehicle body, not corresponding to those in the drawings.

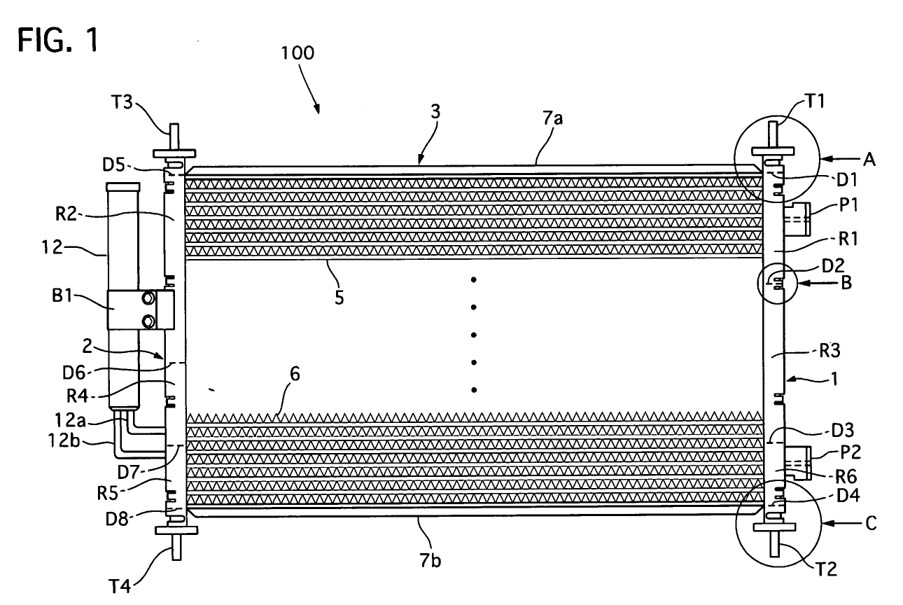

As shown in FIG. 1, the condenser 100 includes a pair of tanks consisting of a left tank 1 and a right tank 2 that are arranged apart from each other in a lateral direction of the vehicle body and a condenser core 3 that is arranged between the left and right tanks 1 and 2 for cooling refrigerant flowing therethrough.

The condenser core 3 has a plurality of tubes 5 for flowing the refrigerant therethrough from one of the left and right tanks 1 and 2 to the other thereof and corrugated fins 6 for radiating heat of the refrigerant flowing in the tubes 5, where the tubes 5 and the corrugated fins 6 are arranged alternately to each other in a vertical direction of the condenser 100 and extend in a horizontal direction thereof. The tubes 5 are fluidically connected with the left and right tanks 1 and 2 at their left and right end portions. The condenser core 3 further has an upper reinforcement member 7a and a lower reinforcement member 7b at its highest position and its lowest position, respectively, their left and right end portions being fixed to the left and right tanks 1 and 2 for ensuring strength of the condenser 100.

The left and right tanks 1 and 2 are constructed almost similarly to each other and arranged in directions opposite to each other.

The left tank 1 is fixed with a left upper mounting bracket T1 and a left lower mounting bracket T2 at its top and bottom end portions, respectively. Similarly, the right tank 2 is fixed with a right upper mounting bracket T3 and a right lower mounting bracket T4 at its top and bottom end portions, respectively.

The left tank 1 is provided with an upper connector P1 and a lower connector P2 at an upper portion and a lower portion thereof, respectively, for fluidically connecting not-shown units, such as a compressor, and an evaporator, of the air conditioning system via not-shown pipes. The right tank 2 is provided with a receiver 12 for gas-liquid separating and temporarily storing excessive refrigerant to regulate a variation of a circulating refrigerant amount, and the receiver 12 is fluidically connected with the right tank 2 through a first connecting pipe 12a and a second connecting pipe 12b.

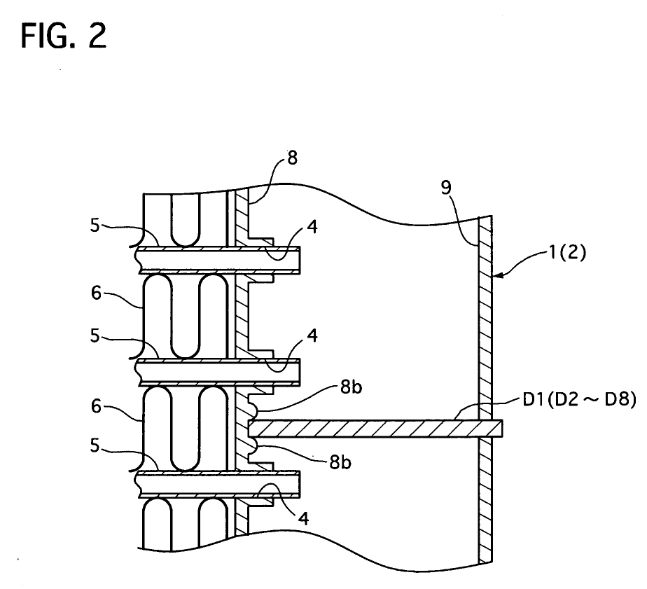

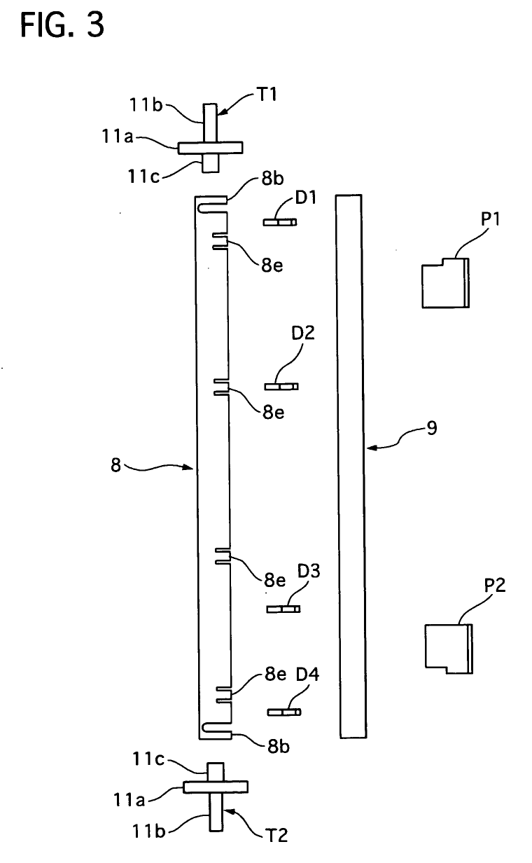

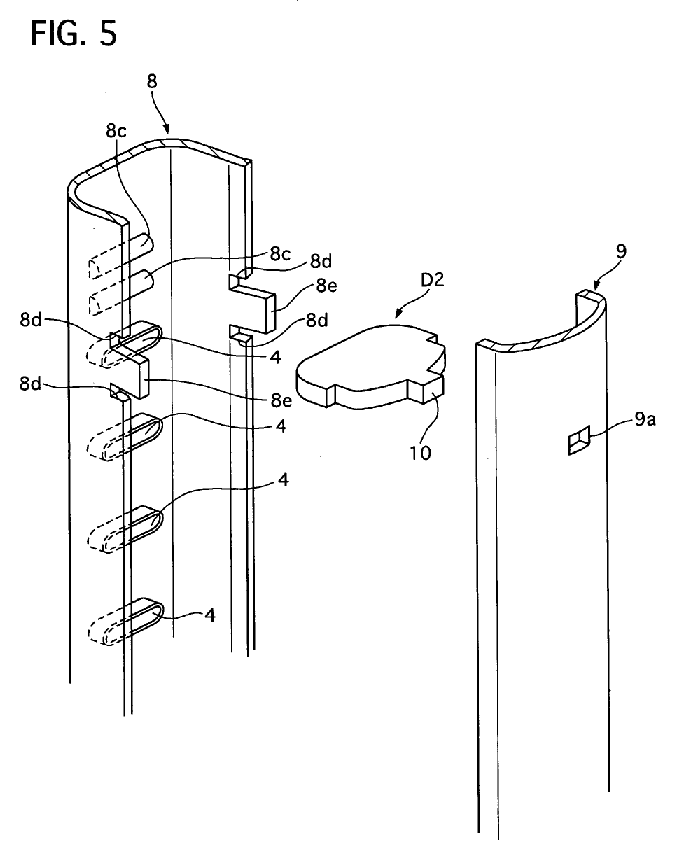

As shown in FIGS. 2 to 6, the left tank 1 is constructed by coupling a tube plate 8 and a tank plate, both of which are shaped in a half-cylinder, with each other to form an interior space having a four-round-cornered rectangle shape in cross section. The interior space of the left tank 1 is divided by four partition plates, consisting of a first partition plate D1, a second partition plate D2, a third partition plate D3 and a fourth partition plate D4, to define the interior space into three rooms, a first room R1, a third room R3, and a sixth room R6 as shown in FIG. 1.

The right tank 2 is also constructed by coupling a tube plate and a tank plate, both of which are shaped in a half-cylinder, with each other to form an interior space having a four-round-cornered rectangle shape in cross section. The interior space of the right tank 2 is divided by four partition plates, consisting of a fifth partition plate D5, a sixth partition plate D6, a seventh partition plate D7 and an eighth partition plate D8, to define the interior space into three rooms, a second room R2, a fourth room R4, and a fifth room R5 as shown in FIG. 1.

The first and fifth partition plates D1 and D5 of the left and right tanks 1 and 2 are located in the same height and at a position higher than those of the other partition plates. The second partition plate D2 of the left tank 1 is located higher than the sixth partition plate D6 of the right tank 2, which is located higher than the third partition plate D3 of the left tank 1. The third partition plate D3 of the left tank 1 and the seventh partition plate D7 of the right tank 2 are located in the same height and higher than the fourth partition plate D4 of the left tank 1 and the eighth partition plate D8 of the right tank 2. The fourth partition plate D4 and the eighth partition plate D8 are in the same height. Although the seventh partition plate D7 and the third partition plate D3 are located in the same height, the fourth room R4 is fluidically connected with the fifth room R5 through the first connecting pipe 12a, the receiver 12 and the second connecting pipe 12b.

Accordingly, the refrigerant can flow in turn from the upper connector P1 through the first room R1 of the left tank 1, the tubes 5 connecting the first room R1 and the second room R2, the second room R2 of the right tank 2, the tubes 5 connecting the second room R2 and the third room R3, the third room R3 of the left tank 1, the tubes 5 connecting the third room R3 and the fourth room R4, the fourth room R4 of the right tank 5, the first connecting pipe 12a, the receiver 12, the second connecting pipe 12b, the fifth room R5 of the right tank 2, the pipes 5 connecting the fifth room R5 and the sixth room R6, the sixth room R6 of the left tank 1 toward the lower connector P2.

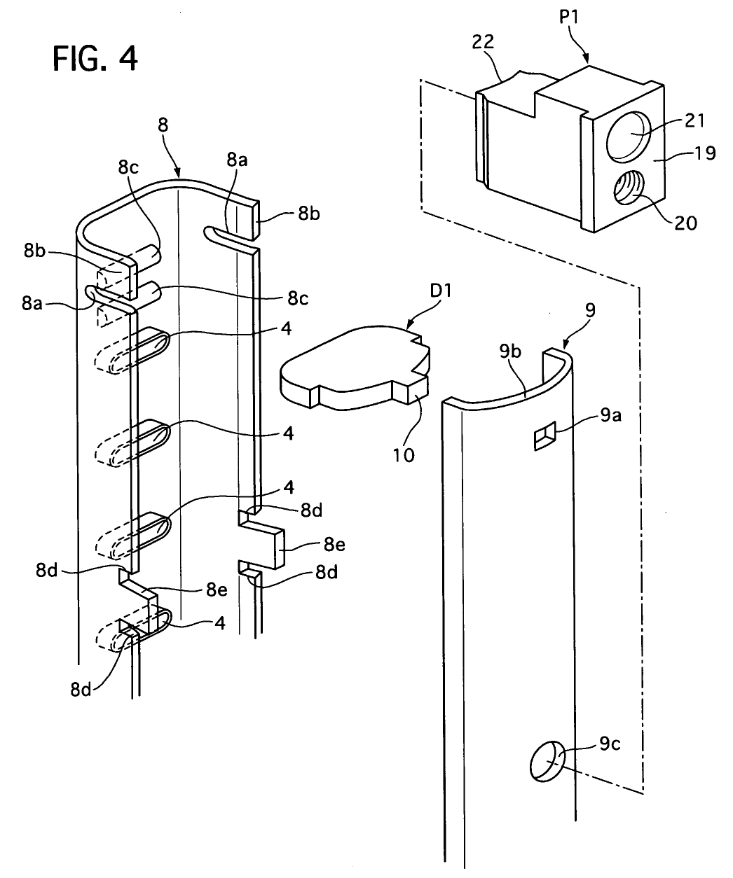

In order to fix the first to eighth partition plates D1 to D8 on the left and right tanks 1 and 2, as shown in FIGS. 4 to 6, the tube plates 8 of the left and right tanks 1 and 2 are formed on their inner surfaces with four pairs of inwardly projecting portions 8c for clamping one side portions of the first to fourth partition plates D1 to D4 and the fifth to eighth partition plates D5 to D8, respectively, and the tank plates 9 of the left and right tanks 1 and 2 are formed with four openings 9a for receiving projecting portions 10 formed on the other side portions of the first to fourth partition plates D1 to D4 and the fifth to eighth partition plates D5 to D8, respectively. The inwardly projecting portions 8c are formed in a half-cylindrical shape in this embodiment, but their configuration may be set arbitrarily.

The tube plates 8 of the left and right tanks 1 and 2 are formed with a plurality of tube-holes 4 so that the tube-holes 4 are inserted by the end portions the tubes 5 of the condenser cores 3 and receive them.

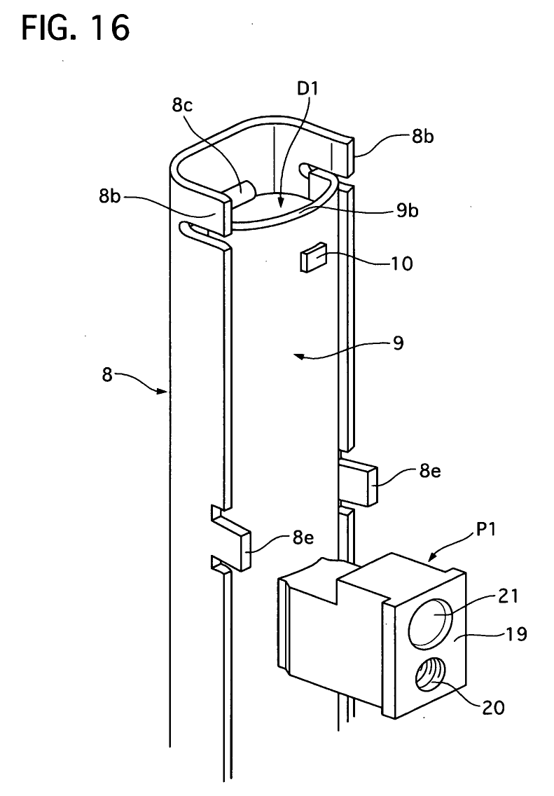

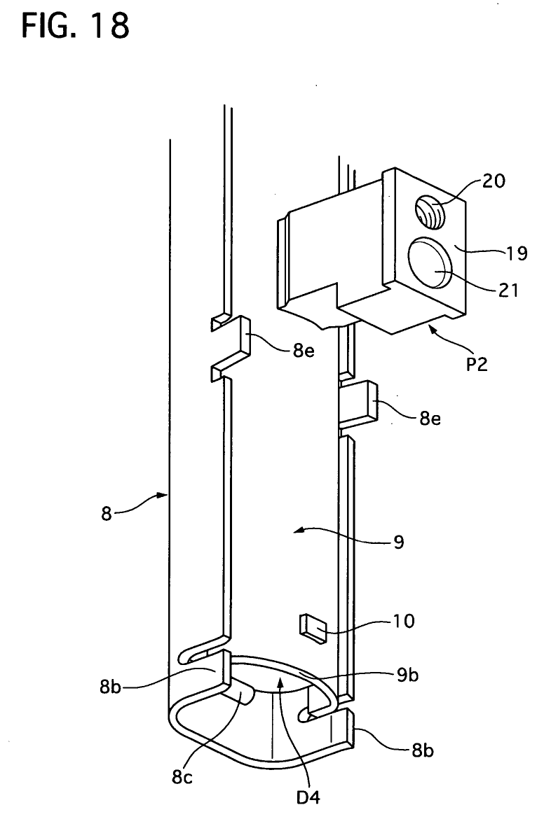

The upper portions and the lower portions of the tube plates 8 respectively have a pair of cut-off portions 8a at their side walls to form a pair of first projecting portions 8b projecting toward the tank plates 9. The tube plates 8 are formed longer in its longitudinal direction than the tank plates 9 so that the first projecting portions 8b can be located over or on top and bottom portions of the tank plates 9 in the vertical direction when the tube plate 8 and the tank plate 9 are coupled with each other as shown in FIGS. 16 and 18. The intermediate portions of the tube plates 8 are formed with eight pairs of cut-off portions 8d at their side walls, two closing pairs thereof being apart from other two closing pairs in the vertical direction, to form a pair of clawing portions 8e located between the two closing pairs of the cut-off portions 8d and projecting toward the tank plates 9. Configuration, positions and the number of the clawing portions 8e may be set arbitrarily.

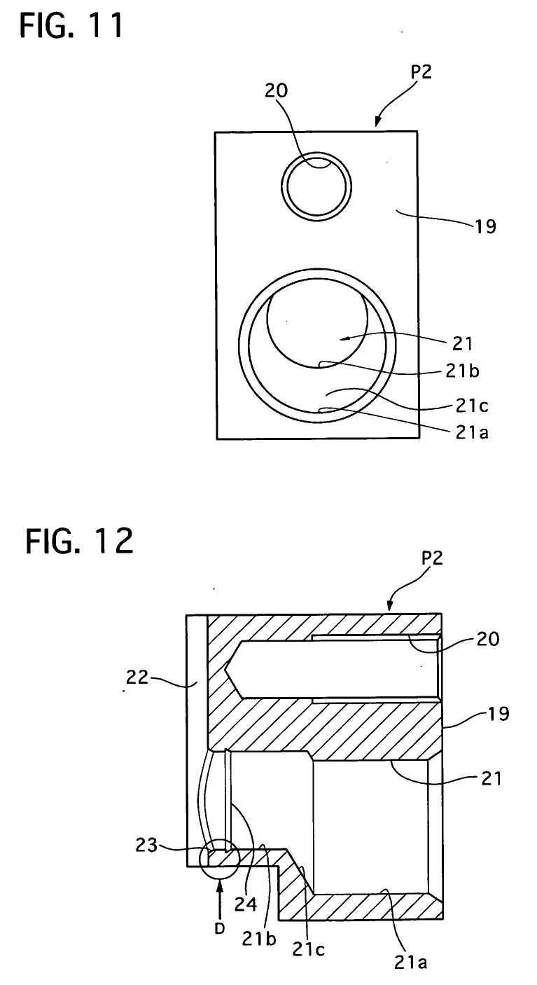

The tank plate 9 of the left tank 1 is formed at its upper and lower portions with upper and lower communicating holes 9c for fluidically communicating with connecting holes 21, shown in FIGS. 11 and 12, of the upper and lower connectors P1 and P2, respectively. The tank plate of the right tank 2 is formed at its intermediate portion with not-shown upper and lower communicating holes for fluidically communicating with the first and second connecting pipes 12a and 12b.

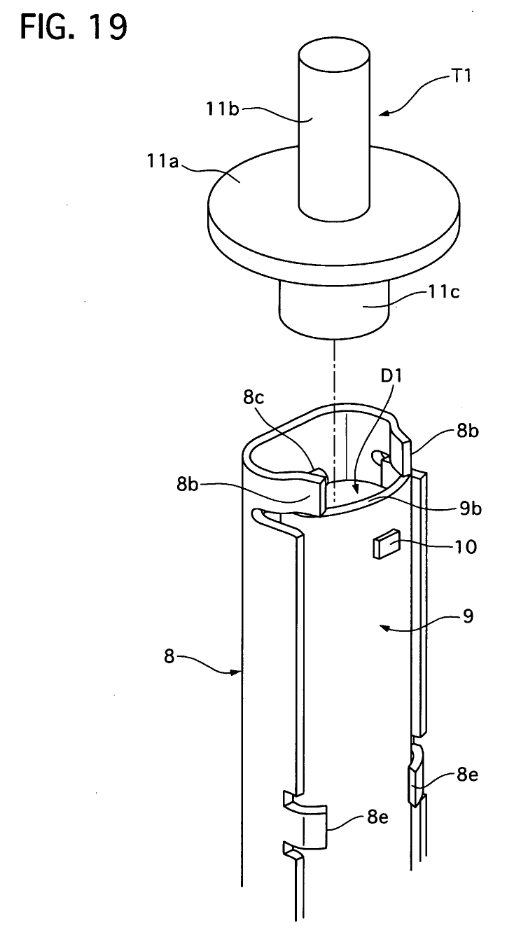

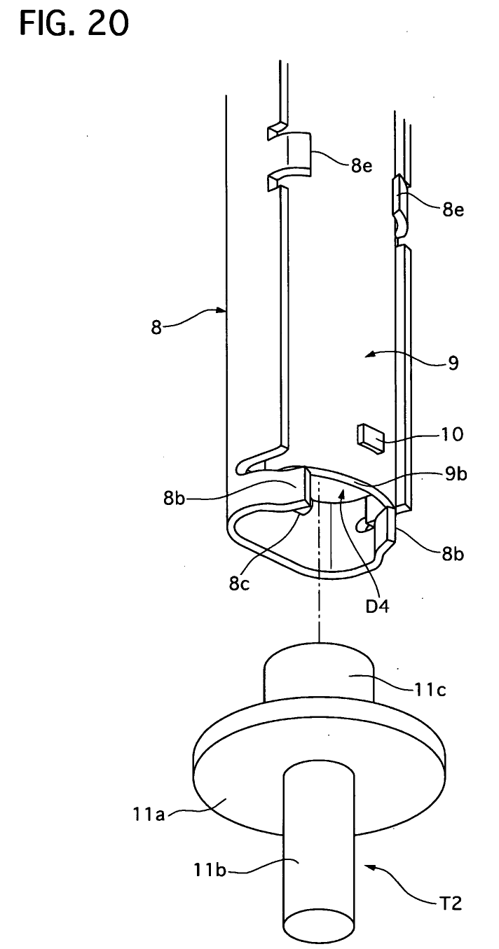

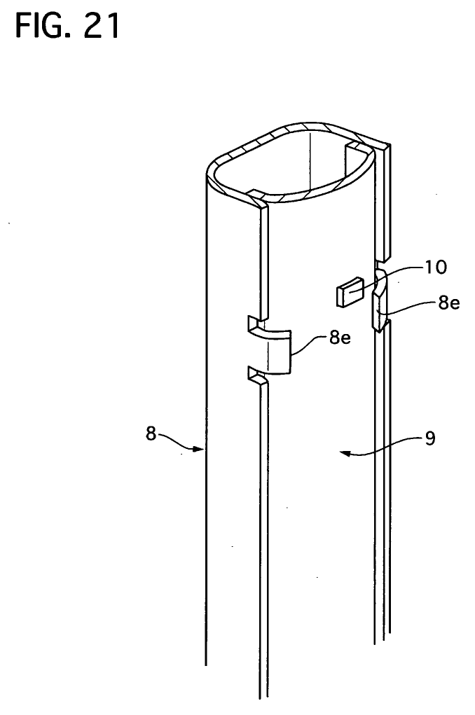

The left and right upper mounting brackets T1 and T3 and the left and right lower mounting brackets T2 and T4 are used for fixing the condenser 100 to a vehicle side, such as a not-shown radiator or a not-shown radiator core support member. As shown in FIGS. 19 and 20, they are formed to have a disc portion 11a, a mounting portion 11b and a fixing portion 11c, where the mounting portions 11b are shaped in a cylindrical column projecting from one-side surface of the disc portion 11a in a direction opposite to the left and right tanks 1 and 2, and the fixing portions 11c are shaped in a cylindrical column projecting from the other-side surface of the disc portion 11a in a direction toward the left and right tanks 1 and 2. Configuration of the mounting brackets T1 to T4 may be set arbitrarily according to a structure fixing the condenser 100 to the vehicle side.

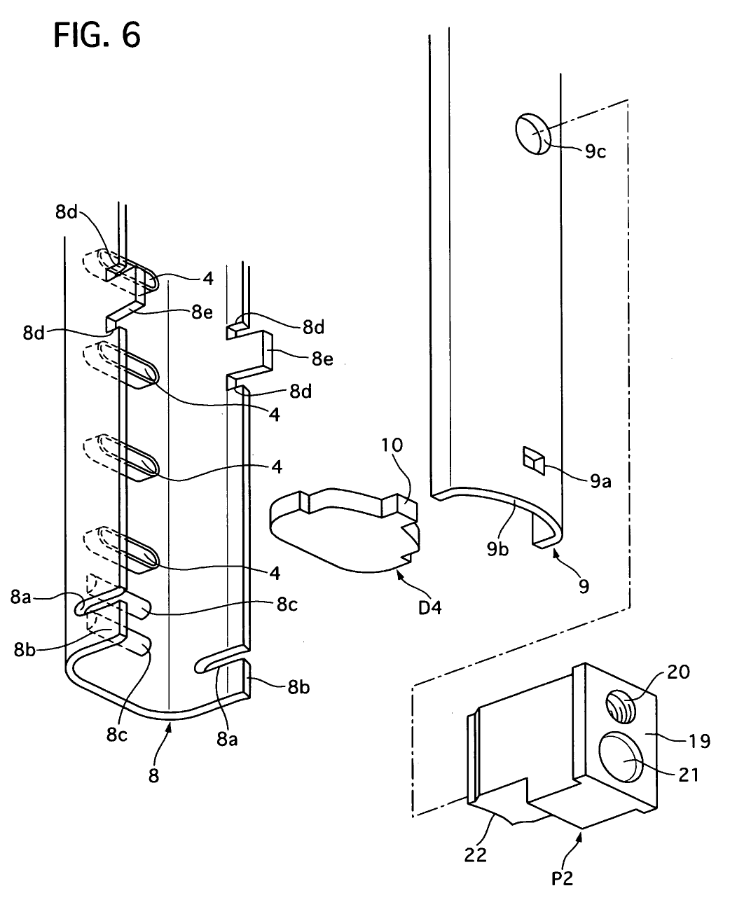

The upper and lower connectors P1 and P2 are constructed similarly to each other, and arranged in different directions as shown in FIGS. 4 and 6.

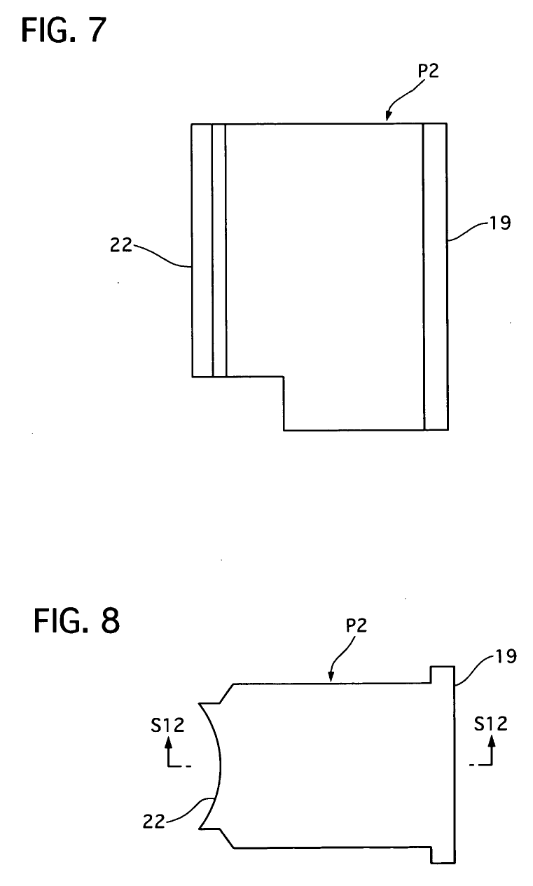

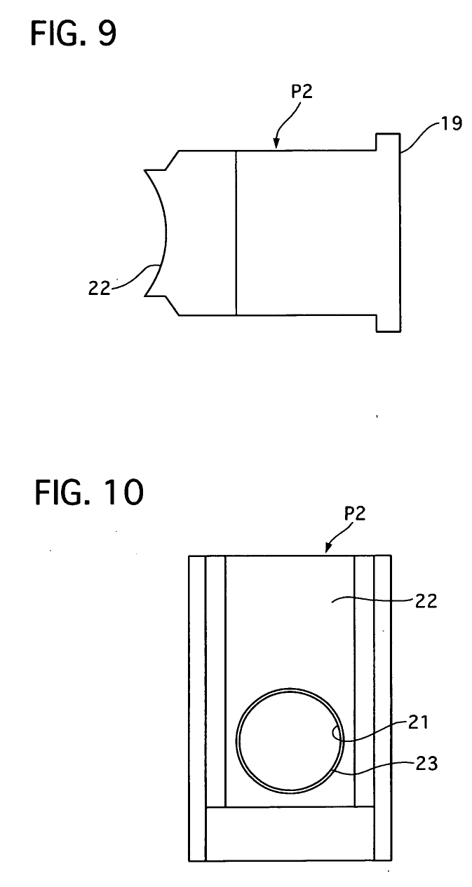

As shown in FIGS. 7 to 11, the lower connector P2 is shaped like a rectangular solid to have a screw hole 20 and the connecting hole 21. The screw hole 20 is formed on a side wall 19 to have a predetermined depth for connecting a not-shown vehicle-side adapter, and the connecting hole 21 is formed in almost parallel to the screw hole 20 to pass through the lower connector P2 from the side wall 19 toward a tube-plate-side side wall 22 for passing the refrigerant therethrough. The connecting hole 21 consists of a large-diameter hole 21a, a small-diameter hole 21b, and a slope hole 21c connecting the large-diameter hole 21a and the small-diameter hole 21b as shown in FIGS. 11 and 12.

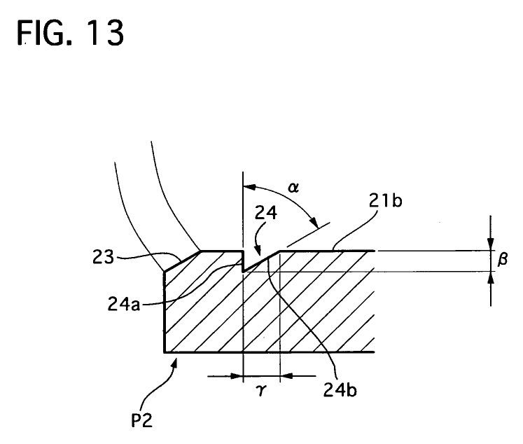

As shown in FIGS. 12 and 13, a holding groove 24 is provided on an inner surface forming the small-diameter hole 21b at a position in close proximity of an opening portion 23 thereof. The holding groove 24 is formed in a circular shape by a vertical wall portion 24a and slope wall portion 24b, where the vertical wall portion 24a extends vertically with respect to a central axis of the small-diameter hole 21b and the slope wall portion 24b extends toward the large-diameter hole 21a, decreasing its depth as a depth position of the slope wall portion 24b goes away from the tank plate 9 in the axial direction of the holding groove 24. The angle α of the slope wall portion 24b, defined by its slope surface and a vertical surface of the vertical wall portion 24a, is set to be approximately 60 degrees in this embodiment. The angle α, a depth β of the vertical wall portion 24a and an axial length γ of the slope wall portion 24b, which are shown in FIG. 13, may be set arbitrarily.

Incidentally, the tube-plate-side side wall portion 22 of the lower connecter P2 is formed to have an arc surface fittable to an outer surface of the tank plate 9. Configuration of the upper and lower connector P1 and P2 may be set arbitrarily according to a fixing structure of a vehicle-side adapter, and profile of the connecting hole 21 is not limited to that of the embodiment in which it is bent in the embodiment.

All parts of the condenser 100, including the left and right tanks 1 and 2, the condenser core 3, the upper and lower reinforcement members 7a and 7b, the receiver 12, the first and second connecting pipes 12a and 12b, the mounting brackets T1 to T4 and the upper and lower connectors P1 and P2, are made of aluminum. The condenser 100 is obtained by blazing connecting portions of the parts.

The condenser 100 is manufactured as follows.

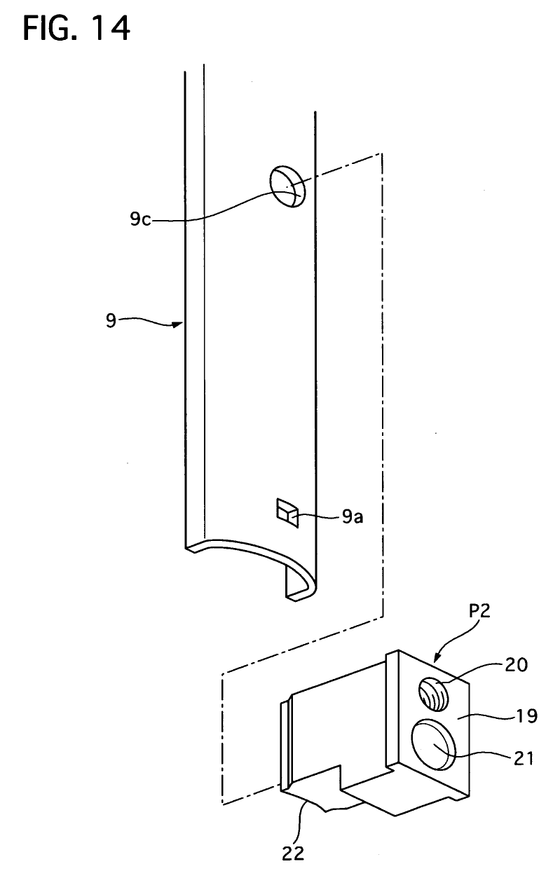

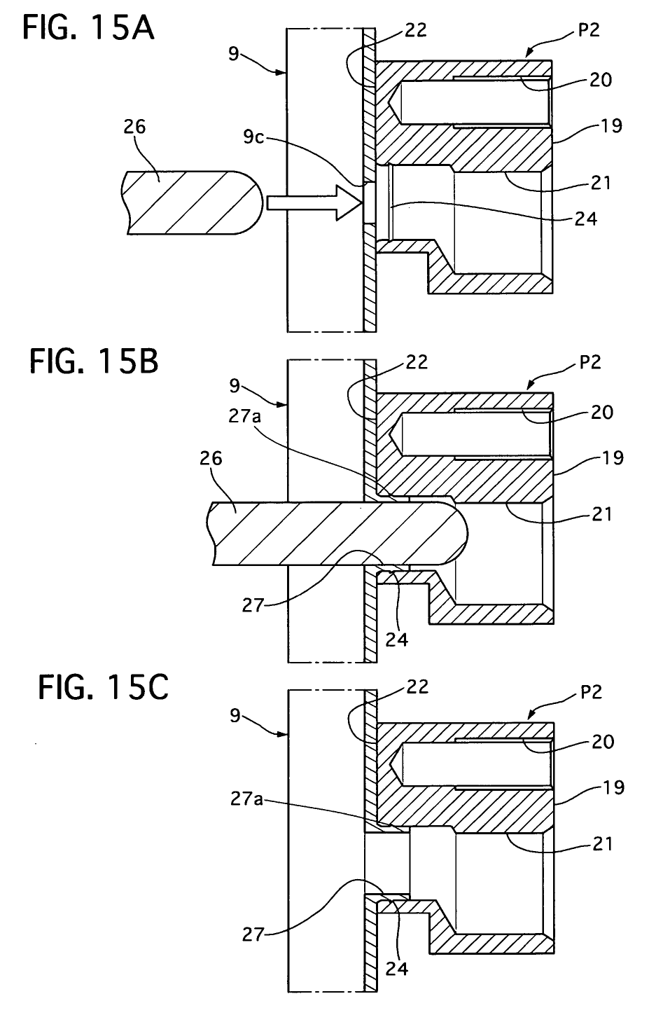

In order to build the left and right tanks 1 and 2, the lower connector P2 is brought to contact with the tank plate 9 as shown in FIG. 14 so that the connecting hole 21 of the lower connecter P2 is aligned with the communicating hole 9c of the tank plate 9 as shown in FIG. 15A.

Then, as shown in FIG. 15B, a punch 26 is pressed into the communicating hole 9c and the connecting hole 21 from the tank plate 9 side to deform a communicating-hole peripheral portion of the tank plate 9 and form a burring portion 27 extending into the connecting hole 21. This burring portion 27 is caulked to be temporarily fixed on the inner surface of the connecting hole. In addition, a part of outer peripheral portion of the burring portion 27 is press-fitted into the holding groove 24 of the lower connecter P2.

The temporary fixing of the tank plate 9 and the lower connector P2 by caulking is maintained after the punch 26 is drawn out from the connecting hole 21 and the communicating hole 9c as shown in FIG. 15C.

In this caulking process, root portion of the burring portion 27 can be formed to contact with the opening portion 23 of the lower connecter P2, since the opening portion 23 is rimmed to have a slope surface on an inner edge thereof. The part of the outer peripheral portion of the burring portion 27 can be easily deformed and fit into the holding groove 24, by being flown toward the vertical wall portion 24a, since the slope wall portion 24b forces it to direct toward a bottom of the holding groove 24. That is, the part of the burring portion 27 forms an inserted projecting portion 27a, where it is inserted into the bottom of the holding groove 24 along the vertical wall portion 24a and extends along the slope wall portion 24b in the axial direction for increasing its axial strength.

The vertical wall portion 24a firmly holds the part of the outer peripheral portion of the burring portion 27, improving their temporary fixing.

The upper connector P1 is temporarily fixed to the upper portion of the tank plate 9 similarly to the lower connector P2, and therefore its description is omitted.

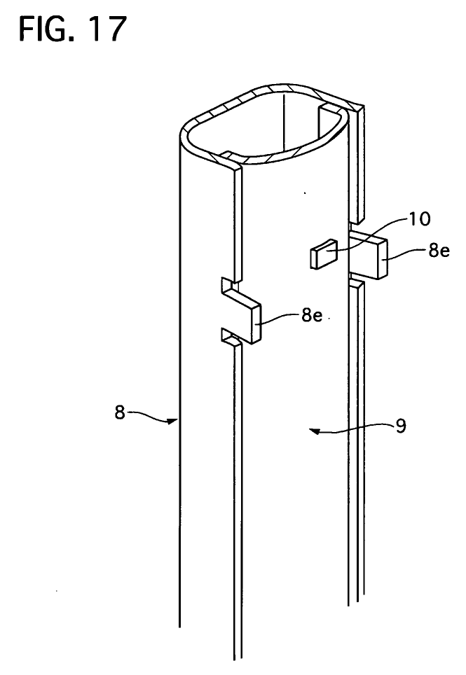

Then, as shown in FIGS. 16, 17 and 18, the first to fourth partition plates D1 to D4 are placed in the tank plate 9, with their projecting portions 10 being inserted into the openings 9a of the tank plate 9. Then, the tube plate 8 is brought to face and lap on the tank plate 9, and their side portions opposite to the projecting portions 10 are inserted between and held by the closing inwardly projecting portions 8c. The tube plate 8 and the tank plate 9 are laid on each other, holding the first to fourth partition plates D1 to D4 therein. In this state where the tube plate 8 receives the tank plate 9 therein, the first projecting portions 8b are positioned over or on the top and bottom end portions of the tank plate 9 as shown in FIGS. 16 and 18.

The upper and lower first projecting portions 8b are bent inwardly to come closer to or contact with the top and bottom end portions of the tank plate 9, respectively, as shown in FIGS. 19 and 20.

The clawing portions 8e are bent inwardly to fix the tank plate 9 by caulking as shown in FIGS. 19 to 20.

Then, the left upper and lower mounting brackets T1 and T2 are temporarily assembled, being inserted between and temporarily fixed by the tube plate 8 and the tank plate 9 at the top and bottom end portions of the left tank 1 as shown in FIGS. 19 and 20.

The right tank 2 is temporarily assembled similarly to the left tank 1 in addition to fixing the receiver 12 and the first and second connecting pipes 12a and 12b instead of the upper and lower connectors P1 and P2, and therefore its description is omitted.

The tubes 5, the corrugated fins 6 and the upper and lower reinforcement members 7a and 7b are temporarily assembled with the left and right tanks 1 and 2. At least one sides of the connecting portions of the condenser 100 are provided with cladding layers, blazing sheets, made of blazing filler metal, and then this temporarily assembled condenser 100 is fed to be placed in a heat furnace, where it is heated so that all the connecting portions can be integrally fixed with each other by blazing.

Incidentally, temporary assembly of the condenser core 3, consisting of the tubes 5, the corrugated fins 6, and the upper and lower reinforcement members 7a and 7b, and the left and right tanks 1 and 2 may be carried out in a proper process. In this embodiment, outer surfaces of the both edge portions of at least the tank plate 9 are provided with cladding layers for fixing it to the tube plate 8 by blazing, and outer surfaces of its intermediate portion are also provided with cladding layer for fixing the upper and lower connectors P1 and P2 thereto by blazing. In addition, the inner surfaces, facing the outer surface of the burring portion 27, of the connecting holes 21 of the upper and lower connectors P1 and P2 may be provided with cladding layers for fixing the burring portions 27 of the tank plate 9 thereto by blazing.

Note that a relative movement between the tube plate 8 and the tank plate 9 in the axial direction thereof are restricted by the first projecting portions 8b, and the inwardly projecting portions 8c and the openings 9a both for receiving the partition plates D1 to D8 in a temporary assembly process and in a blazing process.

After a blazing process, the condenser 100 is conveyed and attached on a not-shown radiator core by fixing the mounting brackets T1 to T4 to not-shown radiator-core connectors, and then they are mounted on the front portion of the vehicle body to be connected with the vehicle-side units through the pipes.

The operation of the condenser 100 will be described.

The first room R1 of the condenser 100 is fed with the refrigerant at approximately 70° C. through the connecting hole 21 of the upper connector P1 from a not-shown compressor. The refrigerant in the first room R1 flows toward the second room R2 via the tubes 5 connecting between the first and second rooms R1 and R2, where it is cooled by heat radiation through the corrugated fins 6 hit by air flow caused by vehicle-running and/or a not-shown motor fan.

Then, the refrigerant in the second room R2 flows toward the third room R3 via the tubes 5 connecting therebetween, where it is cooled similarly to that flowing between the first and second rooms R1 and R2. The refrigerant in the third room R3 flows toward the fourth room R4 via the tubes 5 connecting therebetween, being cooled similarly, and the refrigerant in the fourth room R4 flows via the first connecting pipe 12a to the receiver 12, where the refrigerant is separated into gas and liquid to be temporarily stored for regulating a variation of the circulating refrigerant amount. The refrigerant in the receiver 12 goes to the fifth room R5 via the second connecting pipe 12b, and then flows toward the sixth room R6 via the tubes 5 connecting therebetween, being cooled down to approximately 45° C. This cooled refrigerant is discharged through the connecting hole 21 of the lower connector P2 toward a not-shown evaporator.

The condenser 100 of the embodiment has the following advantages.

The burring portions formed on the tank plates 9 are deformed so that its part can be inserted in the holding grooves 24, formed on the inner surface forming the connecting holes 21 of the upper and lower connectors P1 and P2. This provides temporarily and firmly fixing thereof, thereby ensuring desirable and firm blazing.

The holding groove 24 is formed to have the vertical wall portion 24a and the slope wall portion 24b decreasing its depth as the depth position of the slope wall portion 24b goes away from the tank plate 9 in the axial direction of the holding groove 24. The vertical wall portion 24a ensures firm fixing of the tank plates 9 and the upper and lower connectors P1 and P2, and the slope wall portion 24b also ensures the fixing by deforming the part of the burring portion 27 to form the inserted projecting portion 27a, where it is deformed easily into the bottom of the holding groove 24 so as to be inserted into the bottom of the holding groove 24 along the vertical wall portion 24a and extend along the slope wall portion 24b in the axial direction of the connecting hole 21 for increasing its axial strength.

While there have been particularly shown and described with reference to preferred embodiments thereof, it will be understood that various modifications may be made therein, and it is intended to cover in the appended claims all such modifications as fall within the true spirit and scope of the invention.

For example, the holding groove 24 may be formed in a different shape, and may consist of a plurality of holding grooves arranged in the axial direction.

The upper and lower connectors P1 and P2 may be located at the positions different from those of the embodiment, for example, the upper connector P1 may be fixed on one of the left and right tanks 1 and 2 and the lower connector P2 may be fixed on the other thereof. Their configuration, including the holes thereof, may be formed arbitrarily according to need.

The rooms of the left and right tanks 1 and 2 may be set arbitrarily.

The entire contents of Japanese Patent Application No. 2005-273697 filed Sep. 21, 2005 are incorporated herein by reference.

What is claimed is:

1. A condenser comprising:
a pair of tanks, at least one of the tanks being formed with a communicating hole;
a condenser core arranged between the tanks and having a plurality of tubes and fins where one end portions of the tubes are fluidically connected with one of the tanks and the other end portions of the tubes are fluidically connected with the other of the tanks; and
a connector having a connecting hole that can fluidically communicate with the communicating hole of the tank when the connector is fixed on the tank, wherein
a peripheral portion of the communicating hole is pressed into the connecting hole of the connector to form a burring portion which is caulked on an inner face forming the connecting hole of the connector so that the connector and the tank are temporarily fixed with each other, and facing portions of the tank and the connector are integrally fixed with each other by blazing, wherein
the inner surface of the connecting hole is provided with a holding groove to receive an inserted projecting portion formed on a part of an outer surface of the burring portion for holding the connector to the tank.

2. The condenser according to claim 1, wherein
the holding groove has a vertical wall portion formed vertically to a central axis of the connecting hole and a slope wall portion decreasing a depth of the holding groove as a depth position of the slope wall portion goes away in an axial direction of the connecting hole from the tank.

3. The condenser according to claim 2, wherein
the facing portions of the tank and the connector are integrally fixed with each other by blazing.

4. The condenser according to claim 3, wherein
the connector has an opening portion that is rimmed to have a slope surface on an inner edge thereof to be contactable with a root portion of the burring portion.

5. The condenser according to claim 1, wherein
the facing portions of the tank and the connector are integrally fixed with each other by blazing.

6. The condenser according to claim 5, wherein
the connector has an opening portion that is rimmed to have a slope surface on an inner edge thereof to be contactable with a root portion of the burring portion.

7. The condenser according to claim 1, wherein
the connector has an opening portion that is rimmed to have a slope surface on an inner edge thereof to be contactable with a root portion of the burring portion.
